(19) United States
(12) Patent Application Publication
(10) Pub. No.: US 2013/0004657 A1
(43) Pub. Date: Jan. 3, 2013

(54) Enhanced Electrode Composition For Li ion Battery

(75) Inventors: Gang Xu, Shenzhen (CN); Jun Ma, Irvine, CA (US); Yan Zhang, Beijing (CN); Chunliang Qi, Beijing (CN); Dongmei Wei, Beijing (CN)

(73) Assignee: CNANO TECHNOLOGY LIMITED, San Francisco, CA (US)

(21) Appl. No.: 13/437,205

(22) Filed: Apr. 2, 2012

Related U.S. Application Data
(63) Continuation-in-part of application No. 13/006,321, filed on Jan. 13, 2011.

(51) Int. Cl. B05D 5/12; H01B 1/04; B82Y 30/00; B82Y 40/00

(52) U.S. Cl. 427/122; 252/511; 977/752; 977/847

(57) ABSTRACT

Carbon nanotube-based compositions and methods of making an electrode for a Li ion battery are disclosed. It is an objective of the instant invention to disclose a composition for preparing an electrode of battery, optionally a lithium ion battery, with incorporation of a bi-modal diameter distributed carbon nanotubes with more active material by having less total conductive filler loading, less binder loading, and better electrical contact between conductive filler with active battery materials such that battery performance is enhanced.

### PRIORITY

This application is a continuation-in-part and claims priority from U.S. application Ser. No. 13/006,321 filed on Jan. 13, 2011 and incorporated herein in its entirety by reference.

### CROSS-REFERENCE TO RELATED APPLICATIONS

This application is related to U.S. Pat. No. 7,563,427, U.S. 2009/0208708, 2009/0286675; U.S. Ser. No. 12/516,166; U.S. application Ser. No. 13/006,266, filed on Jan. 13, 2011 and U.S. application Ser. No. 13/285,243, filed on Oct. 31, 2011; all incorporated herein in their entirety by reference.

### BACKGROUND OF THE INVENTION

### Field of the Invention

The present disclosure relates to carbon nanotube-based pastes, compositions of carbon nanotube-enhanced electrodes, and methods of making electrodes for a battery, optionally a Li ion battery.

Carbon nanotubes (CNT) have many unique properties stemming from small sizes, cylindrical graphitic structure, and high aspect ratios. A single-walled carbon nanotube (SWCNT) consists of a single graphite, or graphene, sheet wrapped around to form a cylindrical tube. A multiwall carbon nanotube (MWCNT) includes a set of concentrically single layered nanotube placed along the fiber axis with interstitial distance of 0.34 nanometers. Carbon nanotubes have extremely high tensile strength (˜150 GPa), high modulus (˜1 TPa), good chemical and environmental stability, and high thermal and electrical conductivity. Carbon nanotubes have found many applications, including the preparation of conductive, electromagnetic and microwave absorbing and high-strength composites, fibers, sensors, field emission displays, inks, energy storage and energy conversion devices, radiation sources and nanometer-sized semiconductor devices, probes, and interconnects, etc. Carbon nanotubes are often characterized according to tube diameters. Materials possessing smaller diameters exhibit more surface area and fiber strength; larger diameter nanotubes have a smaller surface area to volume ratio, and the surface area is more accessible than smaller nanotubes due to less entanglement. In addition, large diameter nanotubes are often straighter compared to smaller ones; thus large diameter nanotubes extend through more space or volume in a composite matrix.

Carbon nanotubes possess outstanding material properties but are difficult to process and insoluble in most solvents. Historically polymers such as poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO) and natural polymers have been used to wrap or coat carbon nanotubes and render them soluble in water or organic solvents. Previous work also reports single-walled carbon nanotubes (SWCNTs) have been dispersed with three types of amphiphilic materials in aqueous solutions: (i) an anionic aliphatic surfactant, sodium dodecyl sulfate (SDS), (ii) a cyclic lipopeptide biosurfactant, surfactin, and (iii) a water-soluble polymer, polyvinylpyrrolidone (PVP).

Conventional electro-conductive pastes or inks are comprised primarily of polymeric binders which contain or have mixed in lesser amounts of electro-conductive filler such as finely divided particles of metal such as silver, gold, copper, nickel, palladium or platinum and/or carbonaceous materials like carbon black or graphite, and a liquid vehicle. A polymeric binder may attach the conductive filler to a substrate and/or hold the electro-conductive filler in a conductive pattern which serves as a conductive circuit. The liquid vehicle includes solvents (e.g., liquids which dissolve the solid components) as well as non-solvents (e.g., liquids which do not dissolve the solid components). The liquid vehicle serves as a carrier to help apply or deposit the polymeric binder and electro-conductive filler onto certain substrates. An electro-conductive paste with carbon nanotubes dispersed within is a versatile material wherein carbon nanotubes form low resistance conductive networks.

### BACKGROUND

Background and supporting technical information is found in the following references, all incorporated in their entirety herein by reference; U.S. Pat. No. 4,427,820, U.S. Pat. No. 5,098,711, U.S. Pat. No. 6,528,211, U.S. Pat. No. 6,703,163, U.S. Pat. No. 7,008,563, U.S. Pat. No. 7,029,794, U.S. Pat. No. 7,365,100, U.S. Pat. No. 7,563,427, U.S. Pat. No. 7,608,362, U.S. Pat. No. 7,682,590, U.S. Pat. No. 7,682,750, U.S. Pat. No. 7,781,103, U.S.2004/0038251, U.S.2007/0224106, U.S.2008/0038635, U.S.2009/0208708, U.S.2009/0286675, U.S.2010/0021819, U.S.20100273050, U.S.2010/0026324, U.S.2010/0123079, 2010/0143798, 2010/0176337, U.S.2010/0300183, U.S.2011/0006461, U.S.2011/0230672, U.S.2011/0171371, U.S.2011/0171364; zHAO, BIN, et al.; “Synthesis and Properties of a water-soluble single-walled caron nanotube-Poly(m-aminobenzene sulfonic acid) graft copolymer; Adv. Funct. Mater. 2004, 14, No. 1, January, 71; LI, YADONG, et al.; “Bismuth Nanotubes: A Rational low-temperature Synthetic Route”; J. Am. Chem. Soc.; 2001, 123, 9904; LI, LAIN-JONG, et al.; “Comparative study of photoluminescence of single-walled carbon nanotubes wrapped with sodium dodecyl sulfate, surfactin and polyvinylpyrrolidone”; Instit. of Physics Publishing, nanotechnology; 16, (2005) 5202; ZHANG, XIEFEI, et al.; “Poly(vinyl alcohol)/SWNT Composite Film”; Nano Letters 2003 Vol. 3, 9, 1285; LI, LAIN-JONG, et al.; “Chirality Assignment of single-walled carbon nanotubes with strain”; Phys. Rev. Letters, 93, 5, Oct. 2004, 156104-1; KIM, WOON-SOO, et al.; “Electrical Properties of PVdF/PVP Composite filled with carbon nanotubes prepared by floating catalyst method”; Macromolecular Research, 10, 5, 253, (2002); SHEEM, K. Y., et al.; “High-density positive electrodes containing carbon nanotubes for use in Li-ion cells”; Jl. Power Sources 158, (2006) 1425; SHEEM, K. Y., et al.; “Electrostatic heterocaoagulation of carbon nanotubes an LiCoO2 particles for a high-performance Li-ion cell”; Electrochimica Acta 55, (2010) 5808; IU, X. M., et al.; “Sol-gel synthesis of multiwalled carbon nanotube-LiMn2O4 nanocomposites as cathode materials for Li-ion batteries”; Jl. Power Sources 195, (2010) 4290; HILL, JOHN; “How to uniformly disperse nanoparticles in battery cathode coating”; Advanced Materials & Processes, May 2010; 26; CHEN, N.; “Surface phase morphology and composition of the casting films of PVDF-PVP blend”; Polymer, 43, 1429 (2002).

U.S. Pat. No. 6,528,211, granted to Showa Denko, discloses electrode materials for batteries comprising fiber agglomerates having micro-pores and an electrode active material included within the micro-pores; the agglomerates are tangled masses of vapor-grown carbon fibers, VGCF. The carbon fibers are compressed, heated and pulverized to form a battery electrode.

U.S. Pat. No. 7,608,362, granted to Samsung SDI, discloses a composite cathode active material comprising a large diameter material selected from Li based compounds of Ni, Co, Mn, O, Al, and a small diameter active material selected from graphite, hard carbon, carbon black, carbon fiber and carbon nanotubes wherein the weight ratio of the large diameter material to the small diameter material is between about 60:40 to about 90:10; in some embodiments the pressed density of the large diameter material is from 2.5 to 4.0 g/cm³ and the pressed density of the small diameter material is from 1.0 to 4.0 g/cm³. U.S. Pat. No. 7,781,103, granted to Samsung SDI, and co-pending application U.S.2010/0273050 disclose a negative active material for a lithium secondary battery comprising mechanically pulverizing a carbon material and shaping the pulverized material into a spherical shape. Samsung's U.S.2008/0038635 discloses an improved active material for a rechargeable lithium battery comprising an active material and a fiber shaped or tube shaped carbon conductive material attached to the surface of the active material wherein the carbon material is present in an amount from about 0.05 to 20 weight %. In 2006 Sheem and co-workers at Samsung disclosed a Li ion battery cathode wherein MWNT are used as a conducting agent with LiCoO₂ with a density up to 4 gm/cm³. In 2010 Sheem and co-workers at Samsung disclosed a Li ion battery cathode wherein nanotubes are coated on the surface of active LiCoO₂ particles using electrostatic hetero-coagulation.

Liu, et al., disclosed a multiwalled carbon nanotube, MWCNT, —LiMn₂O₄ nanocomposite by a facile sol-gel method.

U.S. Pat. No. 7,682,750, granted to Foxconn, discloses a lithium ion battery comprising an anode comprising a conductive substrate and at least one carbon nanotube array wherein the array comprises a plurality of MWCNT wherein the nanotubes are parallel to each other and perpendicular to the substrate.

U.S. Pat. Nos. 6,703,163, and 7,029,794 granted to Celanese Ventures discloses an electrode for a Li battery comprising a conductive matrix containing a disulfide group wherein a plurality of carbon nanotubes is dispersed in the electrically conductive matrix. In some embodiments the carbon nanotubes are disentangled and dispersed in the conductive matrix.

Vapor grown carbon fibers (VGCF) have long been used as conductive additives for lithium ion batteries. However, due to its large diameter of >150 nm, the required loading of this material in typical Lithium ion battery, usually exceeds 3-4%. Furthermore, only a few systems showed positive effect such as LiCoO₂. For many new cathode materials, such as LiFePO₄, the VGCF showed hardly any improvement.

Nanotek Instruments in U.S.2010/021819, 2010/0143798 and 2010/0176337 disclosed the use of graphene platelets with a thickness less than 50 nm in combination with an electrode active material with a dimension less than 1 micron dispersed in a protective matrix.

John Hill of Netzsch of Exton, Pa. reviewed conventional technology in a paper in May 2010 in Advanced Materials & Processes; Hill discussed the following. The materials in anodes and cathodes within a lithium-ion battery affect voltage, capacity, and battery life. Electrolytes conduct the lithium ions and serve as a carrier between the cathode and the anode when electric currents pass through an external circuit, as shown in FIG. 4. For anodes, graphite is the primary material for lithium-ion batteries. The carbon anode is prepared and applied as a “slurry” coating layer. For cathodes, slurries of manganese, cobalt, and iron phosphate particles are frequent choices. In addition, lithium-cobalt oxide and lithium-manganese oxide are common cathode coatings. However, lithium-iron phosphate (LFP) particles provide improved safety, longer cycles, and longer operating life. Iron and phosphate are also less expensive than other materials, and their high charge capacities make them a good match for plug-in hybrid applications. The particle size distribution (PSD) of the lithium iron phosphate affects the charge and discharge cycle time of the battery. A smaller particle size results in faster discharge capability, but to produce these submicron sizes, more grinding energy from the media mill is needed.

Battery Composition

Lithium-ion batteries (sometimes abbreviated Li-ion batteries) are a type of rechargeable battery in which lithium ions move from the negative electrode (anode) to the positive electrode (cathode) during discharge, and from the cathode to the anode during charge. The three primary functional components of a lithium-ion battery are the anode, cathode, and electrolyte, for which a variety of materials may be used. Commercially, the most popular material for the anode is graphite. The cathode is generally one of three materials: a layered oxide (such as lithium cobalt oxide), one based on a polyanion (such as lithium iron phosphate), or a spinel (such as lithium manganese oxide), although materials such as TiS₂ (titanium disulfide) originally were also used. Depending on the choice of material for the anode, cathode, and electrolyte, the voltage, capacity, life, and safety of a lithium-ion battery can change dramatically. In addition to the three main components, Li-ion batteries also contain polymeric binders, conductive additives, separator, and current collectors. Carbon black such as Super-P™ made by Timcal Corporation is usually used as conductive additives. The instant invention discloses the use of carbon nanotube-based conductive paste for both the cathode and the anode in a Lithium-ion battery. Once deposited inside the active materials, the carbon nanotubes create conductive networks within particulates, so as to enhance overall conductivity and reduce battery internal resistance. A modified battery can have improved capacity and cycle life owing to the conductive network built by carbon nanotubes.

Carbon nanotubes are a new class of conductive materials that can provide much enhanced performance for Lithium ion batteries. However, with the use of carbon nanotubes, the conventional cathode composition can no longer satisfy the requirement due to the specialty of carbon nanotubes versus carbon black. Typically, when carbon black was used as conductive filler in the cathode, the preferred composition is active material/conductive filler/binder is. With carbon nanotubes, this composition will result in poor adhesion of cathode material on its current collector; alternatively, broken coatings when folded or wrapped. The instant invention discloses a carbon nanotube based composition for electrodes that overcomes the deficiencies of the prior art.

Recent developments in Lithium ion batteries indicate the use of non-uniform particle sizes can improve the overall electrode density, hence increase the energy density in term of W·h/g. Conventional conductive fillers such as carbon black, and VGCF are having difficulties making the change in compositions. As disclosed herein, carbon nanotubes alone can improve the efficiency of a Li-ion battery by creating better conductive networks. More sophisticated carbon nanotube network structures can further improve modern battery systems.

### BRIEF SUMMARY OF THE INVENTION

Carbon nanotube-based compositions and methods of making an electrode for a Li ion battery are disclosed. It is an objective of the instant invention to disclose a composition for preparing an electrode of a lithium ion battery with incorporation of carbon nanotubes with more active material by having less conductive filler loading and less binder loading such that battery performance is enhanced. In one embodiment an enhanced electrode composition uses less binder, such as PVDF, thus allowing more electrode material, absolutely and proportionately, by weight, in the composition, which in-turn improves overall storage capacity. It is an objective of the instant invention to disclose a composition for preparing a cathode or anode of lithium ion battery with incorporation of carbon nanotubes such that enhanced battery performance by having less conductive filler loading, less binder loading and more active material.

The instant invention discloses that carbon nanotubes with a combination of large and small diameters are used to accommodate different cathode or anode materials of variable sizes. Generally, cathode and/or anode materials with smaller particle sizes tend to have less pore size under compression, while large particles have more pore volume. Small diameter carbon nanotubes fit in the small space between small cathode and/or anode particles. When large diameter particles exist in an electrode, small diameter nanotubes do not easily fill the space in-between the particles, and hence not be able to make adequate electrical connection. Combinations of large and small carbon nanotubes provide solutions for dealing with various cathode and anode materials of different particle sizes. The ratio of large to small diameter nanotubes depends upon the selection of cathode and/or anode materials, e.g. size, electrical property, etc., and the compression force used to bring all materials together on a current collector. It is known in the art that mixing various sizes of particles in a cathode or anode creates better contact and higher density as compared to the use of a single particle size. Therefore, a compatible, CNT-based conductive filler in terms of appropriate diameters to connect particles of various sizes is necessary.

As described in U.S. Provisional 61/294,537, a conductive paste based on carbon nanotubes is comprised of carbon nanotubes and preferred amount of liquid vehicle as dispersant and/or binder. During investigation, it was surprisingly found that selected liquid vehicles in various combinations can further reduce binder loading requirements. In some embodiments it is possible that PVP and PVDF may undergo strong interaction as shown by N. Chen in “Surface phase morphology and composition of the casting films of PVDF-PVP blend”, Polymer, 43, 1429 (2002). The addition of PVP altered the crystallization of PVDF and hence modified its mechanical and adhesion properties. The decreased of PVDF or combined PVP-PVDF can further improve the battery performance by allowing more addition of cathode material, so that improve the total capacity.

### BRIEF DESCRIPTION OF THE SEVERAL VIEWS OF THE DRAWING(S)

FIG. 1A illustrates a schematic diagram of coating made of active materials, carbon nanotubes and binder on an aluminum film as an electrode of lithium battery. FIGS. 1B and 1C illustrate both large and small cathode and/or anode particles in an electrode layer.

FIG. 2 illustrates a cycle performance of lithium ion battery comprising carbon nanotubes.

FIG. 3 shows the conductive network formed by CNT coating on LiFePO₄ observed under scanning electron microscope (SEM)

FIG. 4 is a schematic of a Li-ion battery showing component parts.

FIG. 5 is an electron micrograph of intrapenetrating large and small diameter carbon nanotubes.

### DETAILED DESCRIPTION OF THE INVENTION

### Definitions

The term “agglomerate” refers to microscopic particulate structures of carbon nanotubes; for example, an agglomerate is typically an entangled mass of nanotubes, the mass having diameters between about 0.5 μm to about 5 mm.

As used herein the term “carbon nanotube” means a hollow carbon structure having a diameter of from about 2 to about 100 nm; for purposes herein we mean multi-walled nanotubes exhibiting little to no chirality. In order to distinguish carbon nanotubes of different diameters, the term “CNT(I)” refers more specifically to nanotubes with diameters between about 5-20 nm; the term “CNT(II) refers more specifically to nanotubes with diameters between about 40-100 nm.

The term “multi-wall carbon nanotube”, MWNT, refers to carbon nanotubes wherein graphene layers form more than one concentric cylinders placed along the fiber axis.

The term “carbon nanotube-based paste” refers to an electro-conductive composite in which an electro-conductive filler is multi-wall carbon nanotubes.

The term “composite” means a material comprising at least one polymer and at least one multi-wall carbon nanotube and/or agglomerate.

The term “dispersant” refers to an agent assisting dispersing and stabilizing carbon nanotubes in a composite.

The term “carbon nanotube network” refers to a structure consisting of nanotubes with a “bi-modal” distribution, a mixture of two different uni-modal diameter distributions or distributions having only a narrow range of diameters. Large diameter carbon nanotubes, CNT(II), serve as the backbone of various conductive paths, while small diameter nanotubes, CNT(I), serve to connect individual particles. In some embodiments a range of diameters for small carbon nanotubes, CNT(I), is about 10-15 nm; a range for large diameter nanotubes, CNT(II), is about 50-80 nm. In some embodiments a range of diameters for small CNTs is about 5-20 nm; a range for large diameter nanotubes is about 40-100 nm.

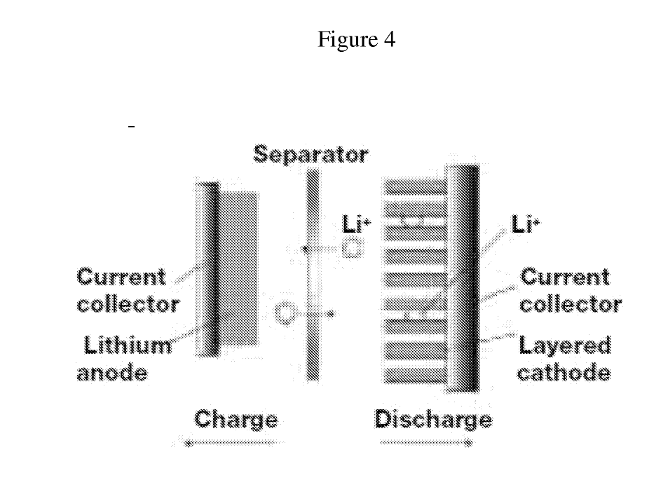

Electrode composition refers to the composition of the electrode active material plus any matrix or composite which may be surrounding the electrode active material. Material of a specific “electrode composition” is coated or bonded to a metallic conductor plate which collects or dispenses electrons, or “current”, when a battery is in an active, discharging, or (re)charging state as shown schematically in FIG. 4.

Carbon Nanotubes

There are various kinds of carbon nanotube structure reported in the art, namely single-walled nanotube, multi-wall nanotube, vapor-phase grown carbon fibers, VGCF, etc. The distinct difference is the diameter, where 0.4-1.2 nm for SWCNT, 2-100 nm for MWCNT, and >100 nm for VGCF.

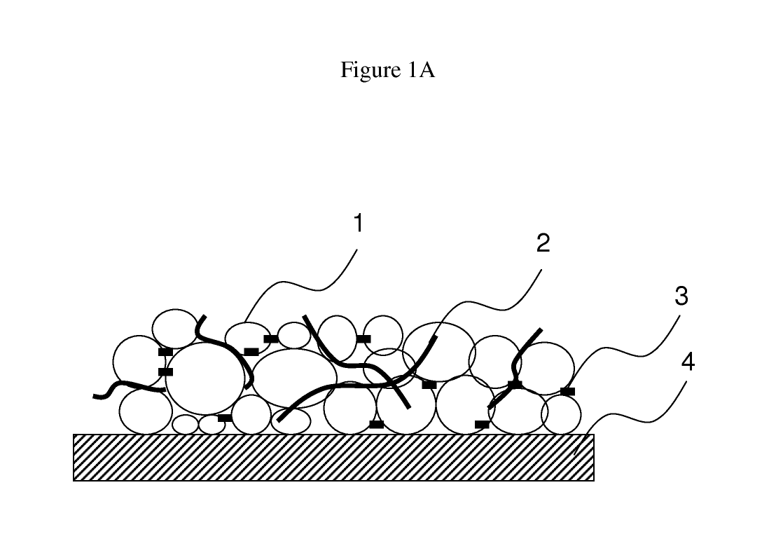

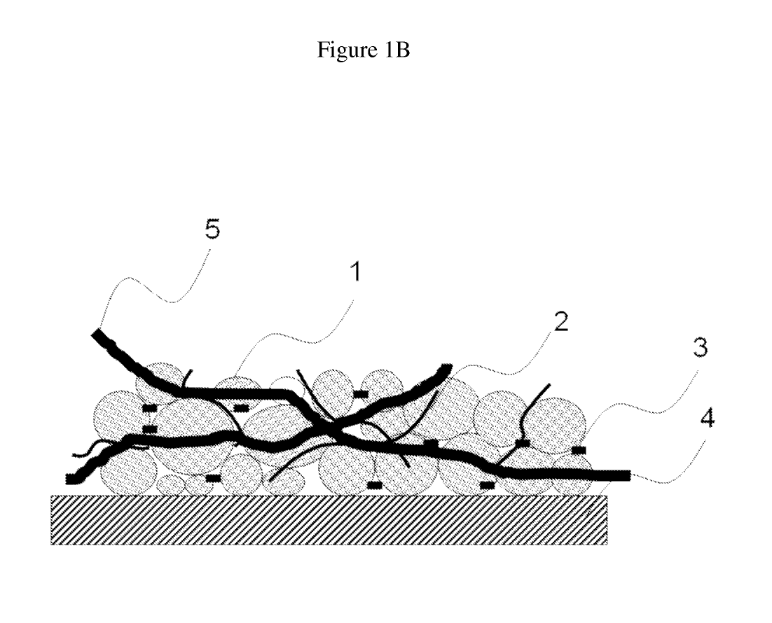

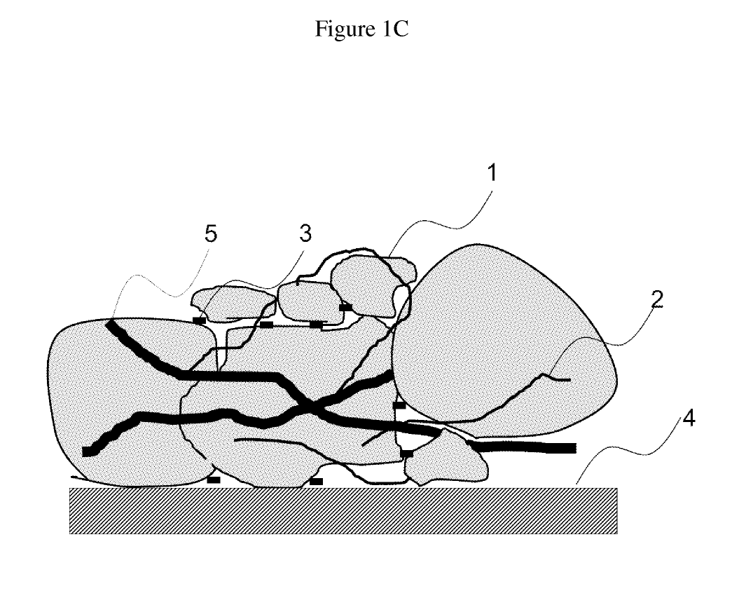

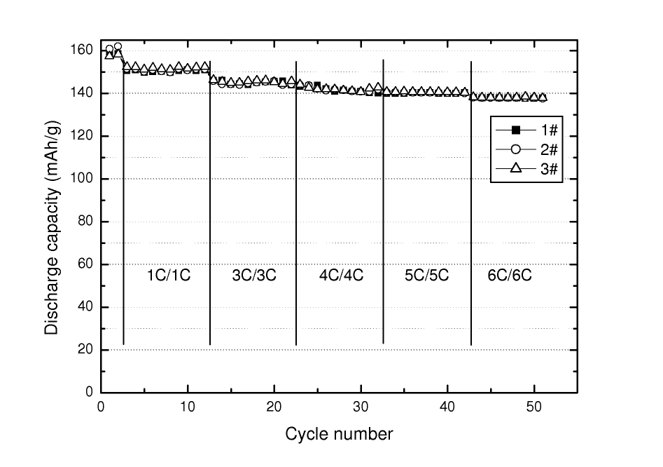

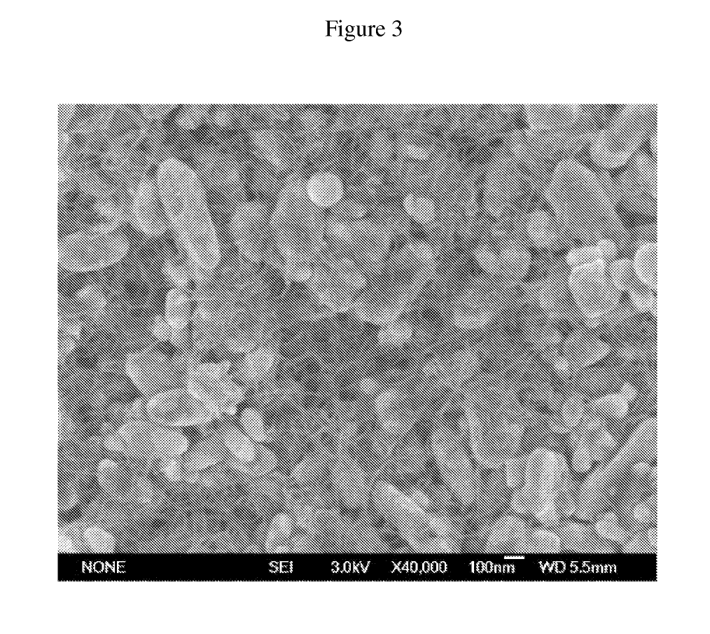

FIG. 1A illustrates a schematic diagram of coating made of active materials 1, carbon nanotubes, CNT(I) 2 and binder 3 on an aluminum film 4 as an electrode of lithium battery. Carbon nanotubes 2, as shown, acted as conductive filler to form electrically conductive path throughout the active material particles, so as to enhance the overall conductivity.

FIG. 1B illustrates both large and small cathode particles 1 in an electrode layer, and mixed, large, CNT(II) 5 and small, CNT(I) 2, diameter carbon nanotubes, and binder 3 forming a carbon nanotube network to accommodate an unconventional packing structure and provide alternative conductive paths.

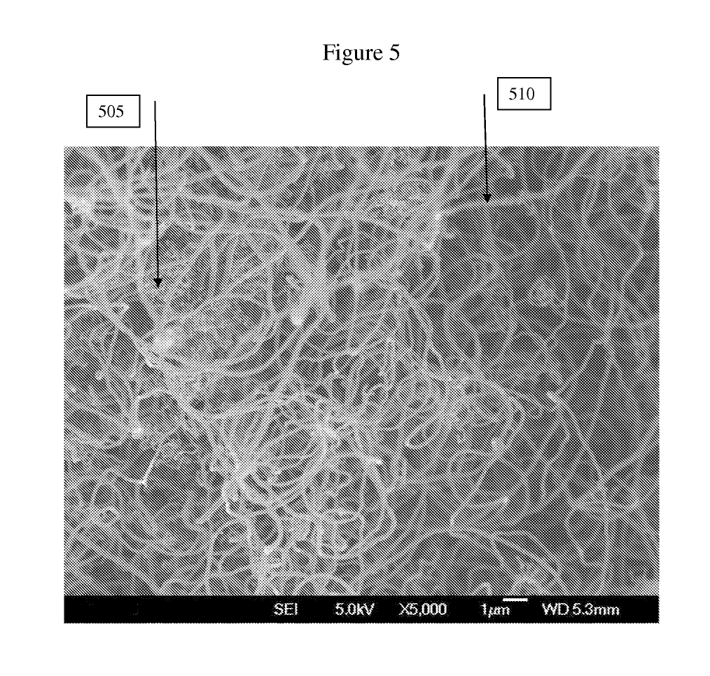

FIG. 1C illustrates schematically both large and small graphite anode particles in an electrode layer, and mixed with large, CNT(II) 5 and small, CNT(I) 2, diameter carbon nanotubes, and binder 3 forming a carbon nanotube network to accommodate an unconventional packing structure and provide alternative conductive paths. FIG. 5 is a SEM at 5,000× showing exemplary of intrapenetrating CNT(I) 505 and CNT(II) 510.

Preparation of carbon nanotubes have been documented extensively. Generally, a catalyst is used in a heated reactor under carbonaceous reagents. At elevated temperatures, the catalyst will decompose carbon precursors and the generated carbon species will precipitate in the form of nanotubes on catalyst particles. A continuous mass production of carbon nanotubes agglomerates can be achieved using a fluidized bed, mixed gases of hydrogen, nitrogen and hydrocarbon at a low space velocity as described in U.S. Pat. No. 7,563,427. As-made, carbon nanotubes often form entanglements, also known as agglomerates. U.S. Pat. No. 7,563,427; incorporated herein by reference in its entirety, describes such agglomerates comprising a plurality of transition metal nanoparticles, a solid support, wherein said plurality of metal nanoparticles and said support are combined to form a plurality of catalyst nano-agglomerates; and a plurality of multi-walled carbon nanotubes deposited on a plurality of catalyst nano-agglomerates. The agglomerates have sizes from about 0.5 to 10,000 micrometers, wherein carbon nanotubes are in the form of multiwall nanotubes having diameters of about 4 to 100 nm. The size of as-made agglomerates can be reduced by various means. A representative characteristic of these agglomerates is their tap density; the tap density of as-made agglomerates can vary from 0.02 to 0.20 g/cm³ depending upon catalyst, growth condition, process design, etc. Rigid agglomerates tend to have high tap densities, while fluffy ones and single-walled nanotubes have low tap densities.

Dispersant

Dispersant serves as an aid for dispersing carbon nanotubes in a solvent. It can be a polar polymeric compound, a surfactant, or high viscosity liquid such as mineral oil or wax. Dispersants used in the current invention include poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, poly(vinyl alcohol), PVA, sodium dodecyl sulfate, SDS, n-methylpyrrolidone, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof. Polymeric binder choices include the dispersants mentioned as well as polyethylene, polypropylene, polyamide, polyurethane, polyvinyl chloride, polyvinylidene fluoride, thermoplastic polyester resin and combinations thereof.

Polyvinylpyrrolidone, PVP, binds polar molecules extremely well. Depending upon its molecular weight, PVP has different properties when used as a binder or as a dispersing agent such as a thickener. In some embodiments of the instant invention, molecular weights for dispersants and/or binders range between about 9,000 and 1,800,000 Daltons; in some embodiments, between about 50,000 to 1,400,000 Daltons are preferred; in some embodiments between about 55,000 to 80,000 Daltons are preferred.

Liquid Vehicle

A liquid vehicle, aqueous or non-aqueous, may serve as a carrier for carbon nanotubes. Liquid vehicles may be a solvent or a non-solvent, depending upon whether or not a vehicle dissolves solids which are mixed therein. The volatility of a liquid vehicle should not be so high that it vaporizes readily at relatively low temperatures and pressures such as room temperature and pressure, for instance, 25° C. and 1 atm. The volatility, however, should not be so low that a solvent does not vaporize somewhat during paste preparation. As used herein, “drying” or removal of excess liquid vehicle refers to promoting the volatilization of those components which can be substantially removed by baking, or vacuum baking or centrifuging or some other de-liquefying process at temperatures below 100 to 200° C.

In one embodiment, a liquid vehicle is used to dissolve polymeric dispersant(s) and entrain carbon nanotubes in order to render a composition that is easily applied to a substrate. Examples of liquid vehicles include, but are not limited to, water, alcohols, ethers, aromatic hydrocarbons, esters, ketones, n-methyl pyrrolidone and mixtures thereof. In some cases, water is used as a solvent to dissolve polymers and form liquid vehicles. When combined with specific polymers these aqueous systems can replace solvent based inks while maintaining designated thixotropic properties, as disclosed in U.S. Pat. No. 4,427,820, incorporated herein in its entirety by reference.

Nanotube Dispersion

Dispersing carbon nanotubes in a liquid is difficult because of the entanglement of nanotubes into large agglomerates. In some embodiments one means of reducing the size of large agglomerates to acceptable size agglomerates is to apply a shear force to an agglomerate; a shear force is one technique to aid with dispersion. Means to apply a shear force include, but are not limited to, milling, sand milling, sonication, grinding, cavitation, or others known to one knowledgeable in the art. In one embodiment, carbon nanotubes are first reduced in size by using a jet-miller. The tap density can decrease after dispersion, optionally by milling, to around 0.06 g/cm³ in some embodiments, or 0.04 g/cm³ in some embodiments, or 0.02 g/cm³ in some embodiments. In some embodiments a colloid mill or sand mill or other technique, is then used to provide sufficient shear force to further break up nanotube agglomerates, as required by an application.

Preparation of Carbon Nanotube Network

Carbon nanotubes, with diameters of about 50 nm but less than about 100 nm, are known to be straighter than smaller nanotubes; smaller nanotubes are often in the form of entangled agglomerates. To form an embodiment of a carbon nanotube network with a “bi-modal” nanotube distribution, small diameter nanotubes are first dispersed into individualized nanotubes in a liquid suspension, such as nMP or water; then large diameter nanotube materials are added directly to the liquid suspension at desired ratio to small diameter nanotubes followed by vigorous agitation and mixing. The resultant paste then contains mixture of both large and small nanotubes crossing each other and forming the desired network in a new paste.

Exemplary lithium ion battery active materials comprise lithium based compounds and or mixtures comprising lithium and one or more elements chosen from a list consisting of oxygen, phosphorous, sulphur, nitrogen, nickel, cobalt, manganese, vanadium, silicon, carbon, aluminum, niobium and zirconium and iron. Typical cathode materials include lithium-metal oxides, such as LiCoO₂, LiMn₂O₄, and Li(NiₓMn_{y}Co_{z})O₂], vanadium oxides, olivines, such as LiFePO₄, and rechargeable lithium oxides. Layered oxides containing cobalt and nickel are materials for lithium-ion batteries also.

Exemplary anode materials are lithium, carbon, graphite, lithium-alloying materials, intermetallics, and silicon and silicon based compounds such as silicon dioxide. Carbonaceous anodes comprising silicon and lithium are utilised anodic materials also. Methods of coating battery materials in combination with a carbon nanotube agglomerate onto anodic or cathodic backing plates such as aluminum or copper, for example, are disclosed as an alternative embodiment of the instant invention.

Prior art in this topic includes disclosures by Goodenough and Arumugam Manthiram of the University of Texas at Austin showing that cathodes containing polyanions, e.g. sulfates, produce higher voltages than oxides due to the inductive effect of the polyanion. In 1996, Goodenough, Akshaya Padhi and coworkers identified lithium iron phosphate (LiFePO₄) and other phospho-olivines (lithium metal phosphates with olivine structure) as cathode materials. In 2002, Yet-Ming Chiang at MIT showed a substantial improvement in the performance of lithium batteries by boosting the material's conductivity by doping it with aluminum, niobium and zirconium. The exact mechanism causing the increase became the subject of a debate. In 2004, Chiang again increased performance by utilizing iron-phosphate particles of less than 100 nanometers in diameter. This decreased particle density by almost one hundredfold, increased the cathode's surface area and improved capacity and performance.

### Example 1

### Dispersion of Carbon Nanotubes [CNT(I)] in n-Methyl Pyrrolidone

30 grams of FloTube™ 9000 carbon nanotubes manufactured by CNano Technology Ltd., pulverized by jet-milling, were placed in 2-liter beaker. The tap density of this material is 0.03 g/mL. In another 500 milliliter beaker, 6 grams of PVP k90 (manufactured by BASF) was dissolved in 100 grams of n-methyl pyrrolidone. Then the PVP solution was transferred to the nanotubes together with 864 grams n-methyl pyrrolidone. After being agitated for an hour, the mixture was transferred to a colloid mill and ground at a speed of 3,000 RPM. A test sample was taken out every 30 min. for evaluation. Viscosity was taken at 25° C. using Brookfield viscometer for each sample and recorded; Hegman scale reading was taken simultaneously. Maximum dispersion was observed after milling for 90 minutes. The fineness of this paste reached better than 10 micrometer after 60 minutes of milling. This sample was named as Sample A.

### Example 2

### Electrode Paste Preparation

A PVDF solution was prepared by placing 10 g of PVDF (HSV900) and 100 g n-methyl pyrrolidone in a 500-mL beaker under constant agitation. After all PVDF was dissolved, designated amount of paste (Sample A) from Example 1 and PVDF solution were mixed under strong agitation of 500-1000 RPM for 30 minutes. The resultant mixture was named Sample B.

In a separate container, desired weight of active materials such as LiFePO₄ or LiCoO₃ was weighed under nitrogen blanket. Selected amount of Sample B was also added to the active material and the mixture was stirred under high speed, e.g. 5000-7000 RPM for 5 hours. The resultant viscosity measured by Brookfield Viscometer should be controlled at 3000-8000 cps for LFP, or 7000-15000 cps for LiCoO₃. The mixing and stirring was carried out in nitrogen environment and temperature not exceeding 40° C. The resultant sample was named Sample C.

### Example 3

### Electrode Preparation

Clean aluminum foil was chosen as cathode current collector, and placed on a flat plexiglass. A doctor blade was applied to deposit a thin coating of Sample C of thickness of about 40 micrometer on the surface of aluminum foil. The coated foil was then placed in a dry oven at 100° C. for 2 hours. The cathode plate was then roll-pressed to form a sheet. A round disk of coated foil was punched out of the foil and placed in a coin battery cell. Lithium metal was used as anode, and the coin cell was sealed after assemble the cathode/separator/anode and injecting electrolyte. The made battery was then tested for various charging and discharging performance.

### Example 4

### Composition Comparison Between Commercial and Disclosed Electrodes

Various samples containing different cathode materials were prepared using the method described in Example 1-3. The electrode composition is listed in Table 1. The cell capacity was measured against different electrode compositions.

TABLE 1
Comparison of electrode composition

| | | Electrode composition (wt %) | | | | | |
|---|---|---|---|---|---|---|---|
| Cathode | | Active | | | Carbon | | Capacity |
| material | Electrode | material | CNT (I) | dispersant | black | PVDF | (mAh/g) |
| LFP | With CNT | 93 | 3 | 0.75 | | 3 | 139.9 |
| | Commercial | 89 | | | 6 | 5 | 133.5 |
| LCO | With CNT | 98 | 0.75 | 0.19 | | 0.75 | 145.6 |
| | Commercial | 97 | | | 2 | 1.5 | 140.9 |
| NCM | With CNT | 97 | 1 | 0.25 | | 1.5 | 139.1 |
| | Commercial | 96 | | | 3 | 1.5 | 135.4 |

### Example 5

### Mechanical Comparison of Electrode (Crease Test)

The coated aluminum, Al, foil from Example 3 was further tested for adhesion and anti-crease properties. The foil was folded several times until the coating cracked or peeled off the surface. Table 2 indicates how the coated Al foils can survive multiple folding action. The number represented the number of folding times before the failure occurred.

TABLE 2

| Conductive | PVDF | Electrode resistivity | |
|---|---|---|---|
| additives | (%) | (ohm · cm) | Crease times |
| 2% SP | 1% | 13.0/9.8 | 3 |
| | | | 2 |
| | 2% | 13.9/13.3 | 1 |
| 1% CNT | 0.75% | 11/14.58 | 4 |
| | | | 2 |
| | 1% | 9.6/12.2 | 1 |
| | | | 1 |

### Example 6

### Application of Carbon Nanotube Paste on Li-Ion Battery Cathode Material

A CNT(I) paste comprising 2% CNT and 0.4% PVP k30 was selected to make a Lithium-ion coin battery. LiFePO4, manufactured by Phostech/Sud Chemie was used as cathode material and Lithium foil was used as anode. The cathode materials contains LiFePO4, CNT, PVP, and PVDF was prepared by mixing appropriate amount of LiFePO4, CNT paste and PVDF together with n-methyl pyrrolidone in a warren blender. Coating of such paste was made on an Al foil using a doctor blade followed by drying and compression. As a comparison, an electrode was prepared using Super-P carbon black (CB) to replace CNT in a similar fashion as described before. The composition and bulk resistivity of the two battery electrodes were summarized in the following table. Clearly, CNT-added electrode has much lower bulk resistivity than carbon black modified sample with the same concentration.

TABLE 3
Battery composition of CNT and carbon
black modified lithium ion battery

| Content | CNT(I) | CB |
|---|---|---|
| LiFePO4 | 86.8% | 88% |
| Carbon additives | 2% | 2% |
| PVP | 0.4% | — |
| PVDF | 5% | 5% |
| Bulk resistivity (ohm-cm) | 3.1 | 31 |

### Example 7

### Life Cycle Evaluation

A battery assembled using the method described in Example 3 was tested for cycle life performance under different charging rate. FIG. 2 illustrates a carbon nanotube [CNT(I)] embedded electrode exhibiting excellent cycle life performance at various charge rates. The inventors have discovered, however, that the amount of polymeric binder needed in electro-conductive pastes can be eliminated or significantly reduced when using multiwall carbon nanotubes of the present invention as an electro-conductive filler and various polymers, for example, polyvinylpyrrolidone (PVP), as dispersant. As a result, the inventors have discovered that conductivity of electro-conductive pastes can be significantly improved.

In some embodiments an electrode composition comprises carbon nanotube agglomerates; a dispersant; and a liquid vehicle; wherein the carbon nanotube agglomerates are dispersed as defined by a Hegman scale reading of 7 or more; optionally, the carbon nanotubes are multiwall carbon nanotubes; optionally carbon nanotubes are in a spherical agglomerates; optionally, an electrode composition comprises a dispersant selected from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof; optionally the dispersant is poly(vinylpyrrolidone); optionally, a comprises a liquid vehicle selected from a group consisting of water, alcohols, ethers, aromatic hydrocarbons, esters, ketones, n-methyl pyrrolidone and mixtures thereof; optionally, an electrode composition has a solid state bulk electrical resistivity less than 10⁻¹ Ω-cm cm and a viscosity greater than 5,000 cps; optionally, an electrode composition comprises carbon nanotube agglomerates having a maximum dimension from about 0.5 to about 1000 micrometers; optionally, an electrode composition has carbon nanotubes with a diameter from about 4 to about 100 nm; optionally, an electrode composition comprises carbon nanotube agglomerates made in a fluidized bed reactor; optionally, an electrode composition comprises carbon nanotube agglomerates have been reduced in size by one or more processes chosen from a group consisting of jet mill, ultra-sonicator, ultrasonics, colloid-mill, ball-mill, bead-mill, sand-mill, dry milling and roll-mill; optionally, an electrode composition has a tap density of the carbon nanotube agglomerates greater than about 0.02 g/cm³; optionally, an electrode composition comprises carbon nanotube agglomerates present in the range of about 1 to 15% by weight of paste; optionally, an electrode composition has a dispersant is present in the range of 0.2 to about 5% by weight of the paste; optionally, an electrode composition has a ratio of the dispersant weight to carbon nanotube agglomerates weight less than 1.

In some embodiments a method for making an electrode composition comprises the steps: selecting carbon nanotube agglomerates; adding the carbon nanotubes agglomerates to a liquid vehicle to form a suspension; dispersing the carbon nanotubes agglomerates in the suspension; reducing the size of the carbon nanotube agglomerates to a Hegman scale of 7 or less; and removing a portion of the liquid vehicle from the suspension to form a concentrated electrode composition such that the electrode composition has carbon nanotubes present in the range of about 1 to 15% by weight, a bulk electrical resistivity of about 10⁻¹ Ω-cm or less and a viscosity greater than 5,000 cps; optionally, a method further comprises the step of mixing a dispersant with the liquid vehicle before adding the carbon nanotube agglomerates; optionally, a method wherein the dispersing step is performed by a means for dispersing chosen from a group consisting of jet mill, ultra-sonicator, ultrasonics, colloid-mill, ball-mill, bead-mill, sand-mill, dry milling and roll-mill.

In some embodiments an electrode composition consists of multi-walled carbon nanotubes of diameter greater than 4 nm; a dispersant chosen from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof; and a liquid vehicle chosen from a group consisting of water, alcohols, ethers, aromatic hydrocarbons, esters, ketones, n-methyl pyrrolidone and mixtures thereof such that the electrode composition has carbon nanotubes present in the range of about 1 to 15% by weight, a bulk electrical resistivity of about 10⁻¹ Ω-cm or less and a viscosity greater than 5,000 cps; optionally, an electrode composition further consists of lithium ion battery electrode materials chosen from a group consisting of lithium, oxygen, phosphorous, nitrogen, nickel, cobalt, manganese, vanadium, silicon, carbon, aluminum, niobium and zirconium and iron wherein the electrode composition is present in a range from about 2% to about 50% by weight and the viscosity is greater than about 5,000 cps; optionally, an electrode composition further consists of a polymeric binder; optionally, an electrode composition is contacting a metallic surface to form an electrode for a lithium ion battery and the liquid vehicle is removed.

In some embodiments a method of preparing an battery electrode coating using a paste composition as disclosed herein comprises the steps: mixing the paste composition with lithium ion oxide compound materials; coating the paste onto a metallic film to form an electrode for a lithium ion battery and removing excess or at least a portion of the liquid from the coating; optionally, a method further comprises the step of mixing a polymeric binder with a liquid vehicle before mixing the paste composition with lithium ion battery materials; optionally, a method uses a polymeric binder chosen from a group consisting of polyethylene, polypropylene, polyamide, polyurethane, polyvinyl chloride, polyvinylidene fluoride, thermoplastic polyester resins, and mixtures thereof and is less than about 5% by weight of the paste composition; optionally, a method utilizes spherical carbon nanotube agglomerates fabricated in a fluidized bed reactor as described in Assignee's inventions U.S. Pat. No. 7,563,427, and U.S. Applications 2009/0208708, 2009/0286675, and U.S. Ser. No. 12/516,166. Optionally, a paste composition as disclosed herein utilizes spherical carbon nanotube agglomerates fabricated in a fluidized bed reactor as described in Assignee's inventions U.S. Pat. No. 7,563,427, and U.S. Applications 2009/0208708, 2009/0286675, and U.S. Ser. No. 12/516,166.

In some embodiments an electrode material composition, or electrode material, for coating to a metallic current collector or metal conductor for a lithium battery comprises multi-walled carbon nanotubes in an agglomerate; electrode active materials chosen from a group consisting of lithium, oxygen, phosphorous, sulphur, nitrogen, nickel, cobalt, manganese, vanadium, silicon, carbon, graphite, aluminum, niobium, titanium and zirconium and iron; a dispersant chosen from a group consisting of poly(vinylpyrrolidone) (PVP), poly(styrene sulfonate) (PSS), poly(phenylacetylene) (PAA), poly(meta-phenylenevinylene) (PmPV), polypyrrole (PPy), poly(p-phenylene benzobisoxazole) (PBO), natural polymers, amphiphilic materials in aqueous solutions, anionic aliphatic surfactant, sodium dodecyl sulfate (SDS), cyclic lipopeptide biosurfactant, surfactin, water-soluble polymers, carboxyl methyl cellulose, hydroxyl ethyl cellulose, poly(vinyl alcohol), PVA, sodium dodecyl sulfate, SDS, n-methylpyrrolidone, polyoxyethylene surfactant, poly(vinylidene fluoride), PVdF, carboxyl methyl cellulose (CMC), hydroxyl ethyl cellulose (HEC), polyacrylic acid (PAA), polyvinyl chloride (PVC) and combinations thereof; and a polymeric binder chosen from a group consisting of polyethylene, polypropylene, polyamide, polyurethane, polyvinyl chloride, polyvinylidene fluoride, thermoplastic polyester resins and mixtures thereof and is less than about 0.5% to 5% by weight of the electrode material composition wherein the electrode active material is 30-60% by weight, the carbon nanotubes are present in a range from about 0.2 to about 5% by weight, and the dispersant is less than 0.1 to 2% by weight before coating to a metallic current collector; after coating and drying the electrode active material is more than 80% by weight and in some embodiments more than 90% by weight; optionally, an electrode material composition comprises carbon nanotube agglomerates made in a fluidized bed reactor; optionally, an electrode material composition comprises carbon nanotube agglomerates with a maximum dimension from about 0.5 to about 1000 microns; optionally, an electrode material composition comprises carbon nanotubes with a diameter from about 4 to about 100 nm; optionally, an electrode material comprises carbon nanotubes wherein the tap density of the carbon nanotube agglomerates is greater than about 0.02 g/cm³; optionally, an electrode material comprises material wherein the bulk resistivity of the material is less than 10 ohm-cm; optionally less than less than 1 ohm-cm; optionally less than 0.1 ohm-cm.

In some embodiments a method of preparing an electrode material using the electrode material composition herein disclosed comprises the steps: forming a paste composition comprising carbon nanotube agglomerates, dispersant and polymeric binders; mixing the paste composition with a lithium ion battery active material composition wherein the paste composition is in a range from about 1% to about 25.0% by weight of the mixed composition; coating the mixed paste composition and active material composition onto a metal conductor; and removing excess volatile components to form an electrode for a lithium ion battery such that after removal of the excess volatile components the active material composition is more than about 80% by weight of the coated paste and battery material composition; optionally, a method wherein the active material composition is more than about 90% by weight of the coated paste and battery material composition after removal of the excess volatile components; optionally, a method further comprising the step of mixing a polymeric binder with a liquid vehicle before mixing the paste composition with lithium ion battery materials; optionally, a method wherein the polymeric binder is chosen from a group consisting of polyethylene, polypropylene, polyamide, polyurethane, polyvinyl chloride, polyvinylidene fluoride, thermoplastic polyester resins, and mixtures thereof and is less than about 5% by weight of the paste composition; optionally, a method wherein the lithium ion battery electrode active materials are chosen from a group consisting of lithium, oxygen, phosphorous, sulphur, nitrogen, nickel, cobalt, manganese, vanadium, silicon, carbon, graphite, aluminum, niobium, titanium, and zirconium and iron; optionally, a method wherein the multi-walled carbon nanotube agglomerates, dispersant and polymeric binders are formed into a dry pellet prior to mixing with the lithium ion battery active material composition. In some embodiments a dry pellet comprising carbon nanotube agglomerates, dispersant and polymeric binders is formed to facilitate shipment to a different location where mixing with a liquid vehicle or additional dispersant may be done prior to coating an electrode composition onto a metallic electrical conductor prior to redrying.

### Example 8

### Preparation of Large Diameter Carbon Nanotubes [CNT(II)] on a Ni/SiO₂ Catalyst

The preparation of large diameter carbon nanotubes was carried out by catalytic decomposition of hydrocarbons such as propylene. A catalyst was prepared using silica gel with average particle size of 5 μm. Nickel nitrate was impregnated on these silica particles in a ratio of about 1 part nickel to 1.5 parts by weight of silica. The resultant particle was then calcined in air at 400° C. for 2 hours. A two (2) inch quartz reactor tube was heated to about 600° C. while it was being purged with nitrogen. A mixed flow of hydrogen, at 1 liter/min and nitrogen at 1 liter/min was fed to the hot tube for five minutes whereupon catalyst was introduced into the reactor tube. The reduction was allowed to carry for about 10 minutes before a mixture of propylene/nitrogen (1:1) mixture was passed through the reactor at 2 liter/min. The reaction was continued for 0.5 hours after which the reactor was allowed to cool to room temperature under argon. Harvesting of the nanotubes so produced showed a yield of greater than 15 times the weight of the catalyst. Final product was retrieved as black fluffy powder. Scan electron micrographs revealed the diameter of carbon nanotubes of 50-70 nm.

### Example 9

### Preparation of Large Diameter Nanotubes [CNT(II)] on a Cu—Ni—Al Catalyst

The catalyst was prepared via co-precipitation of Cu nitrate, Ni nitrate, and Al nitrate. In a round bottom flask, the three nitrates were weighed, and dissolved using deionized water at the molar ratio of Cu:Ni:Al of 3:7:1. Then a solution containing 20% ammonium bicarbonate was slowly added to the flask under continuous agitation. After the pH reached at 9, at which point the precipitation ceased, the resultant suspension was allowed to digest under constant stirring for 1 hour. The precipitates were then washed with deionized water followed by filtration, drying and calcination. The resultant catalyst contained 50 wt % Ni, 24 wt % Cu and 3.5 wt % Al. Nanotubes were prepared following the procedure described in Example 8 at 680° C. using 1 gram of catalyst. A total of 30 g of nanotubes was isolated for a weight yield of 29 times the catalyst. Scan electron micrograph revealed the carbon nanotubes made from this process have average diameters of 80 nm.

### Example 10

### Mixing of Large and Small Nanotubes and Electrode Preparation

CNT (II) were blended with conductive paste containing 5% small nanotubes CNT (I) made from Example 1 at a mass ratio of 3:140 in a Ross mixer for 5 hours; the “140” is the mass of the conductive paste comprising 5% CNT(I), resulting in a mixture of two distinct carbon nanotubes, (I) and (II), at a mass ratio of I:II is 7:3; the proportion of large diameter nanotubes to total nanotube content is 30% by weight. An electrode coating composition was then prepared using paste containing mixed large and small nanotubes with graphite particles, with average diameter of 20 micrometers, together with other necessary binders, such as PVDF. The coating formula was then applied to a Mylar sheet for resistivity measurement, and copper foil to be used as a battery anode. The coated sheet was further subjected to compression under constant pressure, e.g. 10 kg/cm².

The bulk resistivity was measured using a 4-point probe and the results are listed in Table 4.

TABLE 4

| Bulk resistivity | | |
|---|---|---|
| (Ohm-cm) | CNT(I)/Graphite | CNT(I&II)/Graphite |
| Without compression | 0.33 | 0.38 |
| After compression | 0.012 | 0.0086 |

From the data, it is clear that mixed large and small nanotubes provide better electrical contact within a graphite particle matrix and resulted in much decreased bulk resistivity, versus using single sized, small carbon nanotubes, the conductivity is good but not optimized for a spacious pore volume present with large graphite particles.

In some embodiments it is advantageous to have an electrode composition comprising a portion of large diameter carbon nanotubes and a portion of small diameter carbon nanotubes. For purposes of the disclosed invention “large diameter” CNT, CNT(II), is defined as those nanotubes whose diameter is about 40 nm or greater; “small diameter” CNT, CNT(I), is defined as those nanotubes whose diameter is about 20 nm or less. Large diameter nanotubes are typically much longer, at least 1-10 micrometers or longer than small diameter nanotubes, forming major conductive pathways. Small diameter CNT's serve as “local pathways” or networks. In some embodiments the portion, by weight, of large diameter CNTs is between about 5% and 50% with small diameter nanotubes ranging from about 50% to about 95%. Example 10 above is a ratio of “II”/[“I”+“II”]=3/10.

In some embodiments an electrode material composition for a coating applied to a conductive electrode, one of a cathode or anode, for a battery comprises multi-walled carbon nanotubes in an agglomerate comprising a first portion of large diameter carbon nanotubes, CNT(II), and a second portion of small diameter carbon nanotubes, CNT(I), such that the weight ratio of the second portion to the combined weight of the first portion and the second portion is between about 0.05 to about 0.50; electrode active materials; dispersant; and polymeric binder such that the polymeric binder is less than about 0.5% to about 5% by weight of the electrode material composition wherein the electrode active material is in a range of about 30-60% by weight, the total carbon nanotubes are in a range from about 0.2 to about 5% by weight and the dispersant is in a range from about 0.1 to 2% by weight before applying the coating to the electrode; optionally the carbon nanotube agglomerates are made in a fluidized bed reactor; optionally the carbon nanotube agglomerates have a maximum dimension from about 0.5 to about 1,000 microns; optionally the large diameter carbon nanotubes have a diameter in a range from about 40 nm to about 100 nm and the small diameter carbon nanotubes have a diameter in a range from about 5 nm to about 20 nm; optionally the tap density of the carbon nanotube agglomerates is greater than about 0.02 g/cm³; optionally the bulk resistivity of the electrode coating is less than 10 Ohm-cm for cathode and 1 Ohm-cm for anode.

In some embodiments a method of preparing an electrode coating material using the electrode material composition of claim 1 comprises the steps: forming a paste composition comprising carbon nanotube agglomerates, dispersant and polymeric binders; mixing the paste composition with a battery active material composition wherein the paste composition is in a range from about 1% to about 25% by weight of the mixed composition; coating the mixed paste composition and active material composition onto an electrical conductor; and removing excess volatile components to form an electrode for a battery such that after removal of the excess volatile components the active material composition is more than about 80% by weight of the coated paste and battery material composition and the bulk resistivity of the coating is less than about 10 Ohm-cm for a cathode or 1 Ohm·cm for an anode; optionally the active material composition is more than about 90% by weight of the coated paste and battery material composition after removal of the excess volatile components; optionally the method further comprises the step of mixing a polymeric binder with a liquid vehicle before mixing the paste composition with lithium ion battery materials; optionally the polymeric binder is chosen from a group consisting of polyethylene, polypropylene, polyamide, polyurethane, polyvinyl chloride, polyvinylidene fluoride, thermoplastic polyester resins, and mixtures thereof and is less than about 5% by weight of the paste composition; optionally the battery electrode active materials are chosen from a group consisting of lithium, oxygen, phosphorous, sulphur, nitrogen, nickel, cobalt, manganese, vanadium, silicon, carbon, graphite, aluminum, niobium, titanium, and zirconium and iron; optionally the multi-walled carbon nanotube agglomerates, dispersant and polymeric binders are formed into a dry pellet prior to mixing with the battery active material composition.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. All publications, patents, and patent applications cited herein are hereby incorporated by reference in their entirety for all purposes.

What we claim is:

1. An electrode material composition for a coating applied to a conductive electrode, one of a cathode or anode, for a battery comprising;
multi-walled carbon nanotubes in an agglomerate comprising a first portion of large diameter carbon nanotubes, CNT(II), and a second portion of small diameter carbon nanotubes, CNT(I), such that the weight ratio of the second portion to the combined weight of the first portion and the second portion is between about 0.05 to about 0.50;
electrode active materials;
dispersant; and
polymeric binder such that the polymeric binder is less than about 0.5% to about 5% by weight of the electrode material composition wherein the electrode active material is in a range of about 30-60% by weight, the total carbon nanotubes are in a range from about 0.2 to about 5% by weight and the dispersant is in a range from about 0.1 to 2% by weight before applying the coating to the electrode.

2. The electrode material composition of claim 1 wherein the carbon nanotube agglomerates are made in a fluidized bed reactor.

3. The electrode material composition of claim 2, wherein the carbon nanotube agglomerates have a maximum dimension from about 0.5 to about 1,000 microns.

4. The electrode material composition of claim 1, wherein the large diameter carbon nanotubes have a diameter in a range from about 40 nm to about 100 nm and the small diameter carbon nanotubes have a diameter in a range from about 5 nm to about 20 nm.

5. The electrode material composition of claim 1 wherein the tap density of the carbon nanotube agglomerates is greater than about 0.02 g/cm³.

6. The electrode material composition of claim 1 wherein the bulk resistivity of the electrode coating is less than 10 Ohm-cm for cathode and 1 Ohm-cm for anode.

7. A method of preparing an electrode coating material using the electrode material composition of claim 1 comprising the steps:
forming a paste composition comprising carbon nanotube agglomerates, dispersant and polymeric binders;
mixing the paste composition with a lithium ion battery active material composition wherein the paste composition is in a range from about 1% to about 25% by weight of the mixed composition;
coating the mixed paste composition and active material composition onto an electrical conductor; and
removing excess volatile components to form an electrode for a battery such that after removal of the excess volatile components the active material composition is more than about 80% by weight of the coated paste and battery material composition and the bulk resistivity of the coating is less than about 10 Ohm-cm for cathode or 1 Ohm·cm for anode.

8. The method of claim 7 wherein the active material composition is more than about 90% by weight of the coated paste and battery material composition after removal of the excess volatile components.

9. The method of claim 7 further comprising the step of mixing a polymeric binder with a liquid vehicle before mixing the paste composition with lithium ion battery materials.

10. The method of claim 9 wherein the polymeric binder is chosen from a group consisting of polyethylene, polypropylene, polyamide, polyurethane, polyvinyl chloride, polyvinylidene fluoride, thermoplastic polyester resins, and mixtures thereof and is less than about 5% by weight of the paste composition.

11. The method of claim 7 wherein the battery electrode active materials are chosen from a group consisting of lithium, oxygen, phosphorous, sulphur, nitrogen, nickel, cobalt, manganese, vanadium, silicon, carbon, graphite, aluminum, niobium, titanium, and zirconium and iron.

12. The method of claim 7 wherein the multi-walled carbon nanotube agglomerates, dispersant and polymeric binders are formed into a dry pellet prior to mixing with the battery active material composition.
